(19) United States
(12) Patent Application Publication
(10) Pub. No.: US 2007/0286970 A1
(43) Pub. Date: Dec. 13, 2007

(54) Recording paper

(75) Inventors: Takashi Ogino, Kanagawa (JP); Kiyoshi Hosoi, Kanagawa (JP); Chizuru Koga, Kanagawa (JP); Tsukasa Matsuda, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd., Tokyo (JP)

(21) Appl. No.: 11/598,727

(22) Filed: Nov. 14, 2006

(30) Foreign Application Priority Data
Jun. 12, 2006 (JP) 2006-162382

(51) Int. Cl. B41M 5/50

(52) U.S. Cl. 428/32.21

(57) ABSTRACT

A recording paper using at least a cellulose pulp as a raw material includes a thermosetting material which is a natural product, an extract of a natural product or a derivative of a natural product.

### BACKGROUND

1. Technical Field

The present invention relates to a recording paper used for an electrophotographic recording system or ink jet recording system image forming apparatus, and in particular to a recording paper with little curl or problems when running, such as paper winding in a fixing device in a high humidity environment, and furthermore, having a biodegradable property.

2. Related Art

Electrophotographic system image forming apparatuses such as laser printers and copying machines have been employed nowadays in most offices for the characteristics such as the high speed output and the image sharpness. On the other hand, ink jet recording system apparatuses attract the attention for office use for the characteristics such as the ease of changing to color, the small energy consumption, the low noise level when recording, and the low production cost of the printer.

However, both the electrophotographic system image forming apparatuses and the ink jet system image forming apparatuses have a problem of paper curl after the image formation. In a electrophotographic system image forming apparatus, curl is generated due to the uneven removal of the moisture content of the paper by the thermal fixation so as to generate the paper jamming in the paper conveying path, the paper accumulation in the discharge tray in a curled state, or problems in receiving in a post process device such as generation of stapling error.

Moreover, in the ink jet system image forming apparatuses, curl is generated by the permeation of the moisture content contained in the ink into the paper so that when an image with a high recording density is printed, due to the large curl in the recording paper immediately after printing, paper jamming or rubbing of the image area occurs in the printer.

### SUMMARY

According to an aspect of the present invention, a recording paper using at least a cellulose pulp as a raw material includes a thermosetting material that is a natural product, an extract of a natural product or a derivative of a natural product.

### BRIEF DESCRIPTION OF THE DRAWINGS

FIG. 1 is an explanatory diagram for a curl measuring method in an exemplary embodiment of the present invention.

### DETAILED DESCRIPTION

The present inventors have discussed elaborately a structure of a recording paper capable of achieving the above-mentioned objects. As a result, the inventors have found out the conditions for obtaining a recording paper having little curl even in the case of use for an image forming apparatus with a small size, multiple functions and a high speed property, with little reduction of paper strength in a high humidity environment, and a biodegradable property so as to complete the invention based thereon.

Hereinafter, a recording paper according to an exemplary embodiment of the invention will be explained.

In the exemplary embodiment, the natural product refers to an organic compound derived from a plant, an animal or a microbe. Specifically, a terpene and an alkaloid, a fat and a hormone, an antibiotic, a protein, a nucleic acid and polysaccharides are included.

Moreover, in the exemplary embodiment, the thermosetting material refers to a material with a nature to have a complicated reaction promoted among the polymer chains by heating so as to form a three-dimensional structure, and to be cured like a non-melt state by re-heating.

In the exemplary embodiment, in a recording paper using at least a cellulose pulp, it is necessary to include a natural product, an extract of a natural product or a derivative of a natural product. In the case the substance included in the recording paper is not a natural product, an extract of a natural product or a derivative of a natural product, a biodegradable property can hardly be obtained.

Moreover, in the exemplary embodiment, it is necessary that the above-mentioned substance included in the recording paper is a thermosetting material. With a thermosetting material, even in the case of moisture absorption or removal or stress application onto the recording paper at the time of fixation in an electrophotographic system image forming apparatus or in an ink jet recording system image forming apparatus, since the thermosetting material forms a firm bond among the cellulose pulps of the recording paper, the shape stability of the paper can be improved so as to prevent curl generation. Moreover, in the case of a water soluble paper strength intensifying agent conventionally used, although the strength decline of the recording paper was remarkable due to water molecules infiltration among hydrogen bonds formed with respect to cellulose fibers in a high humidity environment, since the thermosetting material has little reactivity with respect to water, the recording paper strength reduction is slight so that the recording paper winding phenomenon to the fixing device can hardly be generated.

Moreover, as the thermosetting material of a natural product, an extract of a natural product or a derivative of a natural product in the exemplary embodiment, a β 1,3-glucan, a 1,3-glucan derivative, a protein, a phenol derivative of a natural lignin, a shellac, a urushiol, or the like can be used. As long as the paper shape stability can be realized, it is not limited thereto. However, in terms of the color, thermosetting temperature, paper strength rise, it is preferable to select among β 1,3-glucan, a shellac, or a β 1,3-glucan derivative, and a shellac derivative.

Furthermore, it is preferable that the recording paper of the exemplary embodiment has the tensile elastic modulus in the CD of about 3,000 MPa or more. The tensile elastic modulus in the CD of the recording paper in the exemplary embodiment is the value measured by the JIS-P-8113, and it is preferably 3,000 MPa to 8,000 MPa, and it is more preferably about 3,500 MPa to 7,000 MPa. In the case it is less than 3,000 MPa, at the time of thermally fixing the toner and at the time of applying a pressure, the recording paper can easily be deformed, and moreover, due to lacking stiffness of the recording paper, paper winding is generated in the fixing device so as to cause the curl or the paper jamming. Moreover, in the case it is 8,000 MPa or more, in the electrophotographic system image forming apparatus to have the recording paper wound around the transfer device, due to the too strong stiffness of the recording paper, the recording paper may fail to wind around the transfer device so as to generate transfer failures. The CD (cross direction) of the recording paper denotes the transverse direction perpendicular to the MD (machine direction). The MD is the flow direction (conveyance direction) at the time of the paper production.

Moreover, it is preferable that the internal bonding force of the recording paper of the exemplary embodiment is about 0.30 N.m or more. In the case the internal bonding force is less than 0.30 N.m, since the bond formation of the thermosetting material may be insufficient, curl can easily be generated. Moreover, since the reduction of the strength in a high humidity environment is also significant, paper winding may be generated in the fixing device. It is further preferable that the internal bonding force is 0.35 N.m or more in terms of the curl generation restraint and the paper winding prevention in the fixing device. From the viewpoint of the curl generation restraint and the paper winding generation prevention in the fixing device, a larger internal bonding force is preferable, however, from the viewpoint of the recording paper flexibility or the handling convenience, the internal bonding force is preferably 0.50 or less. The internal bonding force is measured by a method mentioned in the attached manual using an internal bond tester produced by KUMAGAYA RIKI Kogyo Corp. according to the method defined in the JAPAN TAPPI No. 18-2.

Moreover, it is preferable that the recording paper of the exemplary embodiment has the content ratio of a thermosetting material in the above-mentioned recording paper of about 0.1% to 5.5% by weight. In the case the content ratio in the recording paper is more than 5.5% by weight, due to the too much absolute weight of the thermosetting material, the flexibility of the recording paper is lacked so that the pages may hardly be turned in the case of producing a brochure. Moreover, in the case it is less than 0.1% by weight, due to the too little absolute weight of the thermosetting material, the CD Young ratio cannot be improved so that at the time of running the recording paper in an electrophotographic system image forming apparatus, or the like, curl grows too much so as to generate a trouble in the machine. From the viewpoint of the recording paper flexibility and the trouble avoidance in the image forming apparatus it is preferably about 0.2% to 5.2% by weight.

As a method for containing the thermosetting material in the recording paper, there are a method of producing a paper by dispersing a thermosetting material in a pulp slurry, and a method of coating a thermosetting material onto a produced paper by means of a size press method, or the like, and any method can be selected. However, in terms of the yield of the thermosetting material into the recording paper, coating by the size press method is most preferable. Moreover, in the case of the size press method, by multiplying the weight ratio of the thermosetting material contained in the size press solution by the adhesion amount of the size press solution in the paper, the content ratio of the thermosetting material in the paper can be calculated.

The recording paper of the exemplary embodiment is the so-called plain paper, which is produced with a plant cellulose fiber such as a wood pulp as the main material with the size press process of a surface sizing agent, or the like applied for the surface strength improvement, the stiffness improvement, or the like to the surface of the recording paper. However, it can be used not only for the plain paper application but also as the printing coat paper base paper. At the time, it can be used as a base paper with a strong tenseness.

As the surface sizing agent in the exemplary embodiment, specifically, among the surface sizing agents, not only an oxidized starch ordinarily used as the surface sizing agent, but also a starch produced by modifying a starch with an enzyme, an acetylated starch with the hydrophobic property improved, a phosphate starch, or the like may be used as well. From the viewpoint of the hydrophobic property of the surface sizing agent, for reducing the hydrophilic carboxyl group, a starch produced by modifying a starch with an enzyme, an acetylated starch, a silicon starch, or the like are more preferable than the conventionally used oxidized starch. Moreover, a polyvinyl alcohol with the saponification degree extremely lowered for leaving a hydrophobic group, or that with the saponification degree extremely heightened for improving the crystallization degree improved for improving the hydrophobic property can also be used preferably. Moreover, for the purpose of improving the image quality of the ink jet system, a polyvinyl alcohol with a low polymerization degree may be used as well. Furthermore, a silanol modified surface sizing agent with the hydrophobic property improved, or the like can be used as well, and these can be used as a mixture or alone by itself.

The surface sizing solution can be provided by including mainly a solvent such as water and the above-mentioned surface sizing agent. Furthermore, a thermosetting material of the exemplary embodiment may also be included.

As to the concentration of the surface sizing solution, since the internal stress generated by swelling of the recording paper at the time of coating and drying thereafter becomes too large if the concentration is too low, it is preferably 5% by weight or more. Moreover, since the sufficient flowability cannot be provided to the surface sizing solution if the concentration of the surface sizing solution is too high, it is preferably prepared in a range of 15% by mass or less. A further preferable range is in a range of 8% to 12% by mass.

The application amount of the above-mentioned surface sizing solution is preferably in a range of 0.1 to 10.0 g/m² per one side of the recording paper in terms of the paper dust generation restraint, however, in the case the thermosetting material of the exemplary embodiment is included, it is preferable to coat such that the content ratio of the thermosetting material in the above-mentioned recording paper is 0.1% to 5.5% by weight.

Moreover, according the recording paper in the exemplary embodiment, the paper moisture content at the time of being kept in a 23° C. 50% RH environment for 16 hours measured based on the JIS-P-8127 is 5.0% or more and 6.3% or less. In the case the paper moisture content is less than 5.0%, the electric resistance of the paper becomes so high that the static electricity is generated at the time of being used in a low humidity environment such as in winter so as to be attracted electrostatically onto a conveyance member in the image forming apparatus. Moreover, in the case the paper moisture content is more than 6.3%, the size change of the paper by the moisture absorption in a high humidity environment becomes too large so as to generate curl or paper jamming. In consideration to the electrostatic attraction with a low moisture content and the size change deterioration with a high moisture content, it is more preferably 5.1% to 6.0%, and it is further preferably 5.1% to 5.5%.

Moreover, it is preferable that the surface temperature of the recording paper in the drying process at the time of producing a recording paper of the exemplary embodiment is 80° C. or more, it is more preferably 90° C. or more, and it is further preferably 100° C. or more. In the case it is less than 80° C., since the thermosetting material can hardly cured by heating due to insufficient drying heat application to the recording paper at the time of producing a recording paper, curl generation can hardly be restrained, and moreover, paper winding in the fixing device may be generated as well. If the recording paper temperature in the drying process is more than 150° C., since the cellulose fiber or the constituent material can be carbonized, it is controlled preferably to a temperature lower than that.

It is preferable that the natural product, the extract of the natural product or the derivative of the natural product in the exemplary embodiment is preferably hardened thermally, however, a thermally unhardened portion may remain. As a confirmation method at the time, it may be analyzed and identified by the Pyrolysis-Gas Chromatography (PyGC)-Mass Analysis device (MS), and it may be analyzed and identified by the GC-MS after decomposing the paper with a cellulase for processing the same to a derivative such as a methylation. Moreover, presence of the ester bond may be confirmed by the infrared spectrophotometer (IR), or the IR spectrum of an organic acid may be confirmed. Moreover, after extracting with alkaline cold water or hot water, it may be separated and identified by a liquid Chromatography (LC), or the like.

The CD stretching ratio of the recording paper in the exemplary embodiment is preferably 0.70% or less, and it is more preferably 0.30 to 0.60%. The CD stretching ratio refers to the size change ratio of the recording paper at the time of repeating for 3 times the absorption/removal processof the moisture content in changing the humidity from “65% R.H.→25% R.H. →65% R.H. →90% R.H.” at the time of leaving the recording paper in a constant temperature environment with the temperature maintained at 23° C., and changing the humidity from “65%R.H. to 25% R.H.” at the third cycle.

For the size measurement of the recording paper, a H.K. type stretching degree tester produced by Oji Engineering Corp is used. The “CD” refers to the direction transverse to the flow direction at the time of producing a recording paper. At the time of measuring the size of the recording paper, the size in the direction transverse to the flow direction at the time of the recording paper production is measured.

For controlling the CD stretching ratio (%) of the paper in a range of 0.70% or less, a method by the shape stability effect as the content of the patent, use of a high freeness pulp as the material by weakening the beating operation of the pulp to be used, use of a keratinized pulse as the material, increase of the basis weight, addition of a dry paper strength intensifying agent, thickening the paper thickness, optimization of the sizing agent and filler inside the paper, reduction of the wet press pressure, reduction of the fiber orientation ratio, or the like can be presented.

Moreover, it is preferable that the surface resistance ratio of the recording paper in the exemplary embodiment is in a range from 1.0×10⁹ Ω/sq to 1.0×10¹¹ Ω/sq, and the volume resistance ratio of the above-mentioned recording paper is in a range from 1.0×10¹⁰ Ω·cm to 1.0×10¹² Ω·cm. In the case it is not in the above-mentioned range, image transfer irregularity may be generated in the electrophotographic system image forming apparatus. According to the recording paper used in the exemplary embodiment, from the viewpoint of obtaining the stable transfer property, it is preferable that the surface resistance ratio is in a range from 5.0×10⁹ Ω/sq to 7.0×10¹⁰ Ω/sq, and the volume resistance ratio is in a range from 1.0×10¹⁰ Ω·cm to 2.0×10¹¹ Ω·cm. The above-mentioned surface resistance ratio and volume resistance ratio are a value measured by the method based on the JIS-K-6911 of a recording paper with the humidity adjusted by maintaining in a 23° C. 50% RH environment for 24 hours.

The recording paper in the exemplary embodiment is made of at least a cellulose pulp. The pulp freeness in the exemplary embodiment denotes the Canada Standard Freeness and a value measured by a measuring method based on the JIS-P-8121. As the cellulose pulp, those conventionally known can be used. Specifically, a chemical pulp, a broadleaf tree bleached craft pulp, a broadleaf tree unbleached craft pulp, a conifer bleached craft pulp, a conifer unbleached craft pulp, a broadleaf tree bleached sulfur pulp, a broadleaf tree unbleached sulfur pulp, a conifer bleached sulfur pulp, a pulp produced by chemically processing wood materials and fiber materials such as cotton, linen, bast, or the like can be used.

Moreover, a grand wood pulp produced by mechanically processing wood materials or chips so as to be a pulp, a chemi-mechanical pulp produced by mechanically processing wood materials or chips after having a chemical solution permeating thereto, and a thermo-mechanical pulp, or the like can also be used. These can be used with only a virgin pulp, or as needed, a waste paper pulp may be added thereto.

Particularly in the case of a pulp to be used as a virgin pulp, it is processed preferably by a bleaching method using a chlorine dioxide without using a chlorine gas (Elementally Chlorine Free; ECF) or a bleaching method mainly using an ozone/hydrogen peroxide, or the like without using a chlorine compound at all (Total Chloine Free).

Moreover, as the material of the above-mentioned waste paper pulp, unprinted waste paper of the upper white, excellent white, medium white, white damage, or the like, cut off, damaged paper, or aligned, generated in the book producing, printing factories, cutting firms, or the like; waste paper drawn with a water based ink, an oil based ink, a pencil, or the like; waste newspaper including fliers as printing upper grade paper, upper grade coat paper, middle grade paper, middle grade coat paper, or the like; waste paper of middle grade paper, middle grade coat paper, groundwood paper, or the like can be included.

The waste paper pulp used for the base paper of the exemplary embodiment, those obtained by processing the above-mentioned waste paper material by at least one of the ozone bleaching process and the hydrogen peroxide bleaching process are preferable.

Moreover, for obtaining a base paper with a higher whiteness, it is preferable to have the composition ratio of the waste paper obtained by the above-mentioned bleaching process by 50% to 100%. Furthermore, from the viewpoint of the reutilization of the resource, it is preferable to have the composition ratio of the above-mentioned waste paper pulp by 70% to 10%.

The above-mentioned ozone process has the function of decomposing a fluorescent dye, or the like ordinarily contained in a upper grade paper, and the hydrogen peroxide process prevents yellowing caused by an alkaline used at the time of the deinking process. Particularly by a process using the two in combination, not only the waste paper deinking process can be facilitated but also the whiteness of the pulp can be improved. Moreover, since the function of decomposing and eliminating the residual chlorine compound in the pulp can also be provided, an enormous effect can be provided in the organic halogenated compound content reduction of the waste paper using a pulp with the chlorine bleaching process.

Filler is preferably added to the paper to adjust opacity, whiteness and surface property of the paper used in the exemplary embodiment. Specifically, when the amount of halogen in the paper is desired to be reduced, the filler which does not contain halogen is preferably used. Examples of the filler which can be used include white inorganic pigments such as heavy calcium carbonate, light calcium carbonate, kaolin, calcined clay, talc, titanium dioxide, zinc oxide, aluminum silicate, synthetic silica, aluminium hydroxide, alumina, sericite, saponite, and bentonite; organic pigments such as plastic pigment, polyethylene and urea resin. When the waste paper is blended, ash content contained in the waste paper raw material need to be estimated beforehand, and the addition amount of the pigment need to be adjusted.

An internally-adding sizing agent is preferably added to the base paper of the exemplary embodiment. A neutral rosin sizing agent, alkenyl succinic anhydride (ASA), alkylketenedimer (AKD), and petroleum resin sizing agent, can be used as the internally-adding sizing agent for acid-free paper.

By applying the surface process to the papers mentioned above using the above-mentioned surface sizing solution, a recording paper of the exemplary embodiment can be obtained. The surface process can be carried out by applying the surface sizing solution onto the above-mentioned paper by a coating means ordinarily used such as a size press, a sim size, a gate roll, a roll coater, a bar coater, an air knife coater, a rod blade coater, and a blade coater. Thereafter, by a drying process with a ho air drier, a cylinder drier, or the like, and a surface smoothing process with various kinds of calendar devices such as a machine calendar, a soft nip calendar, and a super calendar, a recording paper of the exemplary embodiment can be obtained.

The basis weight of the recording paper of the exemplary embodiment is not particularly limited, and it is preferably in a range of 40 to 160 g/m², more preferably in a range of 50 to 130 g/m², and further preferably in a range of 55 to 90 g/m². With a higher basis weight, although it is advantageous in terms of the curl and cockle, if the basis weight is more than 160 g/m², due to the too strong tenseness of the paper, the recording paper running property may be lowered particularly in an image forming apparatus having a point with a large curvature in a conveyance path. Moreover, if it is less than 40 g/m², curl generation can hardly be restrained to a small degree, and furthermore, it is not preferable also in terms of show-through.

In the recording paper of the exemplary embodiment, the ration of orientation of fibers is preferably 1.30 or more from the standpoint of improving the manufacturing productivity.

In the past, the ratio of orientation of fibers had been less than 1.30 by increasing the ratio (jet velocity/wire speed) of the velocity of ejecting a pulp slurry on a paper-making wire (jet velocity) to the speed of moving a paper-making wire (wire speed) in paper-making process (that is, relatively speaking, decreasing the speed of moving a paper-making wire). However, it is not required to decrease the wire speed since the exemplary embodiment provides the improvement of curl and paper strength. The ratio of orientation of fibers in the exemplary embodiment is the ratio of orientation of fibers obtained by an ultrasonic sound wave propagation velocity method, and is a value obtained by dividing the ultrasonic soundwave propagation velocity of the MD of the paper (paper conveying direction in a paper machine) by the ultrasonicsound wave propagation velocity of the CD of the paper (the direction perpendicular to the paper conveying direction in the paper machine), and the ratio of orientation of fibers is represented by the following equation. Ratio of orientation of fibers of base paper obtained by an ultrasonic sound wave propagation velocity method, (T/Y ratio)=ultrasonic sound wave propagation velocity of the MD of the paper/ultrasonic sound wave propagation velocity of the CD of the paper.

The ratio of orientation of fibers obtained by an ultrasonic sound wave propagation velocity method is measured by using SonicSheetTester (trade name, manufactured by Nomura Trading Company).

Further, the recording paper of the exemplary embodiment preferably contains a cationic polymer and a polyvalent salt in order to improve printing suitability in an ink jet recording system image forming apparatus

When the recording paper contains a cationic polymer and a polyvalent metal salt, and the ink for ink jet recording ink contains an anionic polymer, the cationic polymer or the metal salt enables extremely fast coalescence of colorant by crosslinking the anionic polymer, and an excellent print image quality can be obtained. In addition, since the infiltration of the ink solvent into the paper is suppressed, the curl and cockle generated immediately after printing, and the generation of the curl and cockle after the printed paper is allowed to stand for drying can be further improved.

As the polyvalent metal sals, chloride, sulfate, nitrate, formate, acetate or the like of barium, calcium, magnesium, zinc, tin, manganese, aluminum and the other polyvalent metals can be used as the polyvalent metal salt. Specific examples include barium chloride, calcium chloride, calcium acetate, calcium nitrate, calcium formate, magnesium chloride, magnesium sulfate, magnesium nitrate, magnesium acetate, magnesium formate, zinc chloride, zinc sulfate, zinc nitrate, zinc formate, tin chloride, tin nitrate, manganese chloride, manganese sulfate, manganese nitrate, manganese formate, aluminium sulfate, aluminium nitrate, aluminium chloride, aluminium acetate. These polyvalent metal salts may be used singly or in combination. Of the polyvalent metal salts, metal salts having a high solubility in water and a high valence are preferable. When the counter ion of the polyvalent metal salt is a strong acid, the yellow discoloration of the paper after applying the polyvalent metal salts to the paper occurs. Accordingly, the polyvalent metal salts are preferably calcium chloride, calcium formate, magnesium chloride, magnesium formate and the like. Although examples of the cationic polymers include cationized cellulose, cationized starch, cationized starch, the cationic polymers of the present invention are not limited thereto. [0044] The cation polymers and polyvalent metal salts listed above can be applied onto the recording paper surface by being mixed in the above-mentioned surface sizing solution, or by applying a coating solution separately produced onto the paper surface. In the latter case, even though a coating solution obtained by dissolving the same in water may be applied directly onto the recording paper (or the paper) at the time of coating, it is commonly used as a mixture with a binder. As to the content of the cation polymer and the polyvalent metal salt contained in the recording paper surface, it is preferably in a range of 0.1 to 2.0 g/m², and it is more preferably in a range of 0.5 to 1.0 g/m². If the content is less than 0.1 g/m², since the reaction with the pigment and the anion polymer in the ink is weakened, image quality deterioration, curl and cockle immediately after printing, and curl and cockle after leaving for drying may be increased as a result. Moreover, if the content is more than 2.0 g/m², due to deterioration of the ink permeation property, the ink drying property at the high speed printing may be deteriorated.

### EXAMPLES

Hereinafter, the exemplary embodiment will be explained more specifically with reference to the examples, however, the scope of the invention is not limited thereby. The “part” and “%” in the examples denote the “part by weight” and “% by weight” unless otherwise specified.

### Example 1

### (Production of the Recording Paper (1))

A pulp dispersion is prepared so as to have the pulp solid component to 0.3% by mass with a middle grade deinked pulp with a 380 ml freeness (It is a deinked pulp obtained from a middle grade waste paper. The same is applied hereinafter.). Paper production is carried out by adding to the pulp dispersion 0.3 part by mass of an anhydrous succinic acid (ASA) internally added sizing agent (produced by Nihon NSC Corp., product name: Fibran-81) and 0.5 part by mass of a cationized starch (produced by Nihon NSC Corp., product name: Cato-304) with respect to 100 parts by mass of the pulp solid component included in the pulp dispersion, and using a 80 mesh wire by an orientation paper producing machine for experiment produced by KUMAGAYA RIKI with the 1,600 m/min production speed and 1.5 kg/cm² paper material ejection pressure conditions. Thereafter, by compressing the set by 10 kgf/cm² for 3 minutes by a square type sheet machine press produced by KUMAGAYA RIKI, and drying the same with a KRK rotation type drying machine produced by KUMAGAYA RIKI by the 120° C. surface temperature and 0.5 m/min rotation speed conditions, a paper with a 68 g/m² basis weight is obtained.

After size pressing the paper with a 8% by mass concentration aqueous solution (surface sizing solution) as the surface size binder prepared by adding 10 parts by mass of a Glauber's salt, 10 parts by mass of a surface sizing agent (produced by ARAKAWA KAGAKU KOGYO Corp., product name: POLYMARON 1355), 50 parts by mass of a β 1,3-glucan (produced by TAKEDA KIRIN SHOKUHIN corp., product name: CARDRUN) with respect to 100 parts by mass of the solid component of a starch oxide (produced by OJI CORN STARCH Corp., product name: Ace A) and heating to 50° C., with a size press for a test produced by KUMAGAYA RIKI so as to have the surface sizing solution adhesion amount of 2.0 g/m², it was dried with a KRK rotation type drying machine produced by KUMAGAYA RIKI with the surface temperature of the drying drum of 100° C. and 1.0 m/min rotational rate conditions, a recording paper (1) with the basis weight of 70 g/m² is obtained.

### Example 2

### (Production of the Recording Paper (2))

A pulp dispersion is prepared so as to have the pulp solid component to 0.3% by mass with a LBKP (broadleaf tree bleached craft pulp, The same is applied hereinafter.) with a 480 ml freeness. By adding to the pulp dispersion 0.3 part by mass of an anhydrous succinic acid (ASA) internally added sizing agent (produced by Nihon NSC Corp., product name: Fibran-81) and 0.5 part by mass of a cationized starch (produced by Nihon NSC Corp., product name: Cato-304) with respect to 100 parts by mass of the pulp solid component included in the pulp dispersion, carrying out the paper production, dehydration and drying with the same conditions as in the example 1, a paper with the basis weight of 68 g/m² is obtained.

After size pressing the recording paper with a 8% by mass concentration aqueous solution (surface sizing solution) as the surface size binder prepared by adding 10 parts by mass of a Glauber's salt, 10 parts by mass of a surface sizing agent (produced by ARAKAWA KAGAKU KOGYO Corp., product name: POLYMARON 1355), 100 parts by mass of a β 1,3-glucan (produced by TAKEDA KIRIN SHOKUHIN corp., product name: CARDRUN) with respect to 100 parts by mass of the solid component of a starch oxide (produced by OJI CORN STARCH Corp., product name: Ace A) and heating to 50° C., with a size press for a test produced by KUMAGAYA RIKI so as to have the surface sizing solution adhesion amount of 2.0 g/m², it was dried with a KRK rotation type drying machine produced by KUMAGAYA RIKI with the surface temperature of the drying drum of 90° C. and 1.0 m/min rotational rate conditions, a recording paper (2) with the basis weight of 70 g/m² is obtained.

### Example 3

### (Production of the Recording Paper (3))

In the same way as in the recording paper (2) except that the 480 ml freeness LBKP is changed to a 380 ml freenessfreeness middle grade deinked pulp in the recording paper (2) and the surface temperature of the drying drum after size pressing is changed from 90° C. to 100° C., a recording paper (3) with the basis weight of 70 g/m² is obtained.

### Example 4

### (Production of the Recording Paper (4))

A pulp dispersion is prepared so as to have the pulp solid component to 0.3% by mass with a middle grade deinked pulp with a 380 ml freeness. Paper production is carried out by adding to the pulp dispersion 0.3 part by mass of an anhydrous succinic acid (ASA) internally added sizing agent (produced by Nihon NSC Corp., product name: Fibran-81) and 0.5 part by mass of a cationized starch (produced by Nihon NSC Corp., product name: Cato-304) with respect to 100 parts by mass of the pulp solid component included in the pulp dispersion, and using a 80 mesh wire by an orientation paper producing machine for experiment produced by KUMAGAYA RIKI with the 1,750 m/min production speed and 1.5 kg/cm² paper material ejection pressure conditions. Thereafter, by compressing the set by 10 kgf/cm² for 3 mimutes by a square type sheet machine press produced by KUMAGAYA RIKI, and drying the same with a KRK rotation type drying machine produced by KUMAGAYA RIKI by the 120° C. surface temperature and 0.5 m/min rotation speed conditions, a paper with a 66 g/m² basis weight is obtained.

After size pressing the paper with a 8% by mass concentration aqueous solution (surface sizing solution) as the surface size binder prepared by adding 10 parts by mass of a Glauber's salt, 10 parts by mass of a surface sizing agent (produced by ARAKAWA KAGAKU KOGYO Corp., product name: POLYMARON 1355), 1,200 parts by mass of a β 1,3-glucan (produced by TAKEDA KIRIN SHOKUHIN corp., product name: CARDRUN) with respect to 100 parts by mass of the solid component of a starch oxide (produced by OJI CORN STARCH Corp., product name: Ace C) and heating to 50° C., with a size press for a test produced by KUMAGAYA RIKI so as to have the surface sizing solution adhesion amount of 4 g/m², it was dried with a KRK rotation type drying machine produced by KUMAGAYA RIKI with the surface temperature of the drying drum of 120° C. and 1.0 m/min rotational rate conditions, a recording paper (4) with the basis weight of 70 g/m² is obtained.

### Example 5

### (Production of the Recording Paper (5))

A pulp dispersion is prepared so as to have the pulp solid component to 0.3% by mass with a LBKP with a 480 ml freeness. Paper production is carried out by adding to the pulp dispersion 0.3 part by mass of an anhydrous succinic acid (ASA) internally added sizing agent (produced by Nihon NSC Corp., product name: Fibran-81), 0.5 part by mass of a cationized starch (produced by Nihon NSC Corp., product name: Cato-304) and 3 parts by mass of a β 1,3-glucan (produced by TAKEDA KIRIN SHOKUHIN corp., product name: CARDRUN) with respect to 100 parts by mass of the pulp solid component included in the pulp dispersion, and using a 80 mesh wire by an orientation paper producing machine for experiment produced by KUMAGAYA RIKI with the 1,600 m/min production speed and 1.5 kg/cm² paper material ejection pressure conditions. Thereafter, by compressing the set by 10 kgf/cm² for 3 mimutes by a square type sheet machine press produced by KUMAGAYA RIKI, and drying the same with a KRK rotation type drying machine produced by KUMAGAYA RIKI by the 120° C. surface temperature and 0.5 m/min rotation speed conditions, a paper with a 68 g/m² basis weight is obtained.

After size pressing the paper with a 8% by mass concentration aqueous solution (surface sizing solution) as the surface size binder prepared by adding 10 parts by mass of a Glauber's salt, 7.5 parts by mass of a surface sizing agent (produced by ARAKAWA KAGAKU KOGYO Corp., product name: POLYMARON 1355), with respect to 100 parts by mass of the solid component of a starch oxide (produced by OJI CORN STARCH Corp., product name: Ace C) and heating to 50° C., with a size press for a test produced by KUMAGAYA RIKI so as to have the surface sizing solution adhesion amount of 2 g/m², it was dried with a KRK rotation type drying machine produced by KUMAGAYA RIKI with the surface temperature of the drying drum of 120° C. and 1.0 m/min rotational rate conditions, a recording paper (5) with the basis weight of 70 g/m² is obtained.

### Example 6

### (Production of the Recording Paper (6))

In the same way as in the recording paper (5) except that the 480 ml freeness LBKP is changed to a 380 ml freeness middle grade deinked pulp in the recording paper (5) and the 3 parts by mass of a β 1,3-glucan is changed to 6 parts by mass, a recording paper (6) with the basis weight of 70 g/m² is obtained.

### Example 7

### (Production of the Recording Paper (7))

A pulp dispersion is prepared so as to have the pulp solid component to 0.3% by mass with a middle grade deinked pulp with a 380 ml freeness. Paper production is carried out by adding to the pulp dispersion 0.3 partt by mass of an anhydrous succinic acid (ASA) internally added sizing agent (produced by Nihon NSC Corp., product name: Fibran-81) and 0.5 part by mass of a cationized starch (produced by Nihon NSC Corp., product name: Cato-304) with respect to 100 parts by mass of the pulp solid component included in the pulp dispersion, and using a 80 mesh wire by an orientation paper producing machine for experiment produced by KUMAGAYA RIKI with the 1,600 m/min production speed and 1.5 kg/cm² paper material ejection pressure conditions. Thereafter, by compressing the set by 10 kgf/cm² for 3 mimutes by a square type sheet machine press produced by KUMAGAYA RIKI, and drying the same with a KRK rotation type drying machine produced by KUMAGAYA RIKI by the 120° C. surface temperature and 0.5 m/min rotation speed conditions, a paper with a 68 g/m² basis weight is obtained.

After size pressing the paper with a 8% by mass concentration aqueous solution (surface sizing solution) as the surface size binder prepared by adding 10 parts by mass of a Glauber's salt, 10 parts by mass of a surface sizing agent (produced by ARAKAWA KAGAKU KOGYO Corp., product name: POLYMARON 1355), 10 parts by mass of a β 1,3-glucan (produced by TAKEDA KIRIN SHOKUHIN corp., product name: CARDRUN) with respect to 100 parts by mass of the solid component of a starch oxide (produced by OJI CORN STARCH Corp., product name: Ace A) and heating to 50° C., with a size press for a test produced by KUMAGAYA RIKI so as to have the surface sizing solution adhesion amount of 2.0 g/m², it was dried with a KRK rotation type drying machine produced by KUMAGAYA RIKI with the surface temperature of the drying drum of 85° C. and 1.0 m/min rotational rate conditions, a recording paper (7) with the basis weight of 70 g/m² is obtained.

### Example 8

### (Production of the Recording Paper (8))

In the same way as in the recording paper (3) except that the surface temperature of the drying drum after size pressing is changed from 120° C. to 75° C. in the recording paper (3), a recording paper (8) with the basis weight of 70 g/m² is obtained.

### Example 9

### (Production of the Recording Paper (9))

In the same way as in the recording paper (3) except that the amount of the β 1,3-glucan is changed from 100 parts by mass to 5 parts by mass in the recording paper (3), a recording paper (9) with the basis weight of 70 g/m² is obtained.

### Example 10

### (Production of the Recording Paper (10))

A pulp dispersion is prepared so as to have the pulp solid component to 0.3% by mass with a middle grade deinked pulp with a 380 ml freeness. Paper production is carried out by adding to the pulp dispersion 0.3 partt by mass of an anhydrous succinic acid (ASA) internally added sizing agent (produced by Nihon NSC Corp., product name: Fibran-81) and 0.5 part by mass of a cationized starch (produced by Nihon NSC Corp., product name: Cato-304) with respect to 100 parts by mass of the pulp solid component included in the pulp dispersion, and using a 80 mesh wire by an orientation paper producing machine for experiment produced by KUMAGAYA RIKI with the 1,750 m/min production speed and 1.5 kg/cm² paper material ejection pressure conditions. Thereafter, by compressing the set by 10 kgf/cm² for 3 mimutes by a square type sheet machine press produced by KUMAGAYA RIKI, and drying the same with a KRK rotation type drying machine produced by KUMAGAYA RIKI by the 120° C. surface temperature and 0.5 m/min rotation speed conditions, a paper with a 65 g/m² basis weight is obtained.

After size pressing the paper with a 8% by mass concentration aqueous solution (surface sizing solution) as the surface size binder prepared by adding 10 parts by mass of a Glauber's salt, 10 parts by mass of a surface sizing agent (produced by ARAKAWA KAGAKU KOGYO Corp., product name: POLYMARON 1355), 1,200 parts by mass of a 1,3-glucan (produced by TAKEDA KIRIN SHOKUHIN corp., product name: CARDRUN) with respect to 100 parts by mass of the solid component of a starch oxide (produced by OJI CORN STARCH Corp., product name: Ace C) and heating to 50° C., with a size press for a test produced by KUMAGAYA RIKI so as to have the surface sizing solution adhesion amount of 5 g/m², it was dried with a KRK rotation type drying machine produced by KUMAGAYA RIKI with the surface temperature of the drying drum of 120° C. and 1.0 m/min rotational rate conditions, a recording paper (10) with the basis weight of 70 g/m² is obtained.

### Example 11

### (Production of the Recording Paper (11))

In the same way as in the recording paper (1) except that the β 1,3-glucan in the recording paper (1) is changed to a water based shellac (produced by NIHON SHELLAC KOGYO Corp., SB#25), a recording paper (11) with the basis weight of 70 g/m² is obtained.

### Example 12

### (Production of the Recording Paper (12))

In the same way as in the recording paper (2) except that the β 1,3-glucan in the recording paper (2) is changed to a water based shellac (produced by NIHON SHELLAC KOGYO Corp., SB#25), a recording paper (12) with the basis weight of 70 g/m² is obtained.

### Example 13

### (Production of the Recording Paper (13))

In the same way as in the recording paper (3) except that the β 1,3-glucan in the recording paper (3) is changed to a water based shellac (produced by NIHON SHELLAC KOGYO Corp., SB#25), a recording paper (13) with the basis weight of 70 g/m² is obtained.

### Example 14

### (Production of the Recording Paper (14))

In the same way as in the recording paper (4) except that the β 1,3-glucan in the recording paper (4) is changed to a water based shellac (produced by NIHON SHELLAC KOGYO Corp., SB#25), a recording paper (14) with the basis weight of 70 g/m² is obtained.

### Example 15

### (Production of the Recording Paper (15))

In the same way as in the recording paper (5) except that the β 1,3-glucan in the recording paper (5) is changed to a water based shellac (produced by NIHON SHELLAC KOGYO Corp., SB#25), a recording paper (15) with the basis weight of 70 g/m² is obtained.

### Example 16

### (Production of the Recording Paper (16))

In the same way as in the recording paper (6) except that the β 1,3-glucan in the recording paper (6) is changed to a water based shellac (produced by NIHON SHELLAC KOGYO Corp., SB#25), a recording paper (16) with the basis weight of 70 g/m² is obtained.

### Example 17

### (Production of the Recording Paper (17))

In the same way as in the recording paper (7) except that the β 1,3-glucan in the recording paper (7) is changed to a water based shellac (produced by NIHON SHELLAC KOGYO Corp., SB#25), a recording paper (17) with the basis weight of 70 g/m² is obtained.

### Example 18

### (Production of the Recording Paper (18))

In the same way as in the recording paper (8) except that the β 1,3-glucan in the recording paper (8) is changed to a water based shellac (produced by NIHON SHELLAC KOGYO Corp., SB#25), a recording paper (18) with the basis weight of 70 g/m² is obtained.

### Example 19

### (Production of the Recording Paper (19))

In the same way as in the recording paper (9) except that the β 1,3-glucan in the recording paper (9) is changed to a water based shellac (produced by NIHON SHELLAC KOGYO Corp., SB#25), a recording paper (19) with the basis weight of 70 g/m² is obtained.

### Example 20

### (Production of the Recording Paper (20))

In the same way as in the recording paper (10) except that the β 1,3-glucan in the recording paper (10) is changed to a water based shellac (produced by NIHON SHELLAC KOGYO Corp., SB#25), a recording paper (20) with the basis weight of 70 g/m² is obtained.

### Comparative Example 1

### (Production of the Recording Paper (R-1))

In the same way as in the recording paper (3) except that the β 1,3-glucan in the recording paper (3) is changed to a polyacrylic amide (produced by ARAKAWA KAGAKU KOGYO Corp., product name: POLYMER SET HP-715), a recording paper (R-1) with the basis weight of 70 g/m² is obtained.

### Comparative Example 2

### (Production of the Recording Paper (R-2))

In the same way as in the recording paper (3) except that the β 1,3-glucan in the recording paper (3) is changed to a bacteria cellulose), a recording paper (R-2) with the basis weight of 70 g/m² is obtained.

### Comparative Example 3

### (Production of the Recording Paper (R-3))

In the same way as in the recording paper (3) except that the β 1,3-glucan is not added, a recording paper (R-3) with the basis weight of 70 g/m² is obtained.

### Comparative Example 4

### (Production of the Recording Paper (R-4))

In the same way as in the recording paper (3) except that the β 1,3-glucan in the recording paper (3) is changed to a chitosan, a recording paper (R-4) with the basis weight of 70 g/m² is obtained.

The structures and the characteristics of the recording papers (1) to (20) and the recording papers (R-1) to (R-4) are shown in the Table 1.

TABLE 1
Recording paper structures

| | | Thermosetting | Size pressing | | | | | | |
|---|---|---|---|---|---|---|---|---|---|
| | | material of | agent | Content ratio of the | | | Internal | CD tensile | |
| | | the natural | adhesion | natural thermosetting | Fiber | Basis | bond | elastic | Paper |
| Trial production | Pulp used | product of the | amount | material in the paper | orientation | weight | strength | modulus | moisture |
| No. | (freeness) | embodiment | (g/m²) | of the embodiment | ratio | (g/m²) | (N · m) | (Mpa) | content(%) |
| Recording paper | Middle grade | B 1,3-glucan | 2 | 0.84 | 1.62 | 70 | 0.30 | 3300 | 6.2 |
| (1) | deinked pulp | | | | | | | | |
| | (freeness | | | | | | | | |
| | 380 ml) | | | | | | | | |
| Recording paper | LBKP (freeness | B 1,3-glucan | 2 | 1.30 | 1.62 | 70 | 0.34 | 3800 | 5.9 |
| (2) | 480 ml) | | | | | | | | |
| Recording paper | Middle grade | B 1,3-glucan | 2 | 1.30 | 1.63 | 70 | 0.32 | 3500 | 6.1 |
| (3) | deinked pulp | | | | | | | | |
| | (freeness | | | | | | | | |
| | 380 ml) | | | | | | | | |
| Recording paper | Middle grade | B 1,3-glucan | 4 | 5.19 | 1.61 | 70 | 0.41 | 4500 | 6.0 |
| (4) | deinked pulp | | | | | | | | |
| | (freeness | | | | | | | | |
| | 380 ml) | | | | | | | | |
| Recording paper | LBKP (freeness | B 1,3-glucan | 2 | It cannot be | 1.59 | 70 | 0.48 | 5000 | 5.8 |
| (5) | 480 ml) | | | quantified as it is | | | | | |
| | | | | added internally. | | | | | |
| Recording paper | Middle grade | B 1,3-glucan | 2 | It cannot be | 1.58 | 70 | 0.43 | 4400 | 5.9 |
| (6) | deinked pulp | | | quantified as it is | | | | | |
| | (freeness | | | added internally. | | | | | |
| | 380 ml) | | | | | | | | |
| Recording paper | Middle grade | B 1,3-glucan | 2 | 0.22 | 1.63 | 70 | 0.28 | 3100 | 6.1 |
| (7) | deinked pulp | | | | | | | | |
| | (freeness | | | | | | | | |
| | 380 ml) | | | | | | | | |
| Recording paper | Middle grade | B 1,3-glucan | 2 | 1.30 | 1.61 | 70 | 0.25 | 2800 | 6.1 |
| (8) | deinked pulp | | | | | | | | |
| | (freeness | | | | | | | | |
| | 380 ml) | | | | | | | | |
| Recording paper | Middle grade | B 1,3-glucan | 2 | 0.11 | 1.59 | 70 | 0.23 | 2500 | 6.2 |
| (9) | deinked pulp | | | | | | | | |
| | (freeness | | | | | | | | |
| | 380 ml) | | | | | | | | |
| Recording paper | Middle grade | B 1,3-glucan | 5 | 6.49 | 1.68 | 70 | 0.43 | 4800 | 5.9 |
| (10) | deinked pulp | | | | | | | | |
| | (freeness | | | | | | | | |
| | 380 ml) | | | | | | | | |
| Recording paper | Middle grade | Shellac | 2 | 0.84 | 1.62 | 70 | 0.31 | 3600 | 6.1 |
| (11) | deinked pulp | | | | | | | | |
| | (freeness | | | | | | | | |
| | 380 ml) | | | | | | | | |
| Recording paper | LBKP (freeness | Shellac | 2 | 1.30 | 1.62 | 70 | 0.36 | 4100 | 5.8 |
| (12) | 480 ml) | | | | | | | | |
| Recording paper | Middle grade | Shellac | 2 | 1.30 | 1.63 | 70 | 0.33 | 3800 | 5.4 |
| (13) | deinked pulp | | | | | | | | |
| | (freeness | | | | | | | | |
| | 380 ml) | | | | | | | | |
| Recording paper | Middle grade | Shellac | 4 | 5.19 | 1.61 | 70 | 0.42 | 4900 | 5.5 |
| (14) | deinked pulp | | | | | | | | |
| | (freeness | | | | | | | | |
| | 380 ml) | | | | | | | | |
| Recording paper | LBKP (freeness | Shellac | 2 | It cannot be | 1.60 | 70 | 0.49 | 5400 | 5.1 |
| (15) | 480 ml) | | | quantified as it is | | | | | |
| | | | | added internally. | | | | | |
| Recording paper | Middle grade | Shellac | 2 | It cannot be | 1.59 | 70 | 0.44 | 4800 | 5.3 |
| (16) | deinked pulp | | | quantified as it is | | | | | |
| | (freeness | | | added internally. | | | | | |
| | 380 ml) | | | | | | | | |
| Recording paper | Middle grade | Shellac | 2 | 0.22 | 1.63 | 70 | 0.29 | 3400 | 6.0 |
| (17) | deinked pulp | | | | | | | | |
| | (freeness | | | | | | | | |
| | 380 ml) | | | | | | | | |
| Recording paper | Middle grade | Shellac | 2 | 1.30 | 1.61 | 70 | 0.26 | 3100 | 6.0 |
| (18) | deinked pulp | | | | | | | | |
| | (freeness | | | | | | | | |
| | 380 ml) | | | | | | | | |
| Recording paper | Middle grade | Shellac | 2 | 0.11 | 1.59 | 70 | 0.24 | 2800 | 6.1 |
| (19) | deinked pulp | | | | | | | | |
| | (freeness | | | | | | | | |
| | 380 ml) | | | | | | | | |
| Recording paper | Middle grade | Shellac | 5 | 6.49 | 1.68 | 70 | 0.44 | 5174 | 5.1 |
| (20) | deinked pulp | | | | | | | | |
| | freeness 380 ml) | | | | | | | | |
| Recording paper | Middle grade | — | 2 | — | 1.63 | 70 | 0.34 | 3800 | 6.4 |
| (R-1) | deinked pulp | | | | | | | | |
| | (freeness 380 | | | | | | | | |
| | ml) | | | | | | | | |
| Recording paper | Middle grade | — | 2 | — | 1.63 | 70 | 0.30 | 3300 | 6.5 |
| (R-2) | deinked pulp | | | | | | | | |
| | (freeness 380 | | | | | | | | |
| | ml) | | | | | | | | |
| Recording paper | Middle grade | — | 2 | — | 1.63 | 70 | 0.19 | 2100 | 6.4 |
| (R-3) | deinked pulp | | | | | | | | |
| | (freeness 380 | | | | | | | | |
| | ml) | | | | | | | | |
| Recording paper | Middle grade | — | 2 | — | 1.63 | 70 | 0.32 | 3500 | 6.5 |
| (R-4) | deinked pulp | | | | | | | | |
| | (freeness 380 | | | | | | | | |
| | ml) | | | | | | | | |

The evaluation results obtained in the Examples 1 to 20 and the Comparative Examples 1 to 4 are shown in the Table 2.

TABLE 2

| | | Evaluation results | | | |
|---|---|---|---|---|---|
| | | Electro- | | | |
| | | photographic | | Ink jet | |
| | | system | | system | |
| | | suitability | | suitability | |
| | | | Paper | Curl | |
| | | Curl | winding | immediately | Curl |
| | | after | in | after | after |
| | Recording paper | fixing | fixing | printing | drying |
| Example 1 | Recording paper | B | B | B | B |
| | (1) | | | | |
| Example 2 | Recording paper | A | A | B | B |
| | (2) | | | | |
| Example 3 | Recording paper | B | A | B | B |
| | (3) | | | | |
| Example 4 | Recording paper | A | A | A | B |
| | (4) | | | | |
| Example 5 | Recording paper | A | A | A | B |
| | (5) | | | | |
| Example 6 | Recording paper | A | A | A | B |
| | (6) | | | | |
| Example 7 | Recording paper | B | B | B | C |
| | (7) | | | | |
| Example 8 | Recording paper | B | C | B | C |
| | (8) | | | | |
| Example 9 | Recording paper | C | C | C | C |
| | (9) | | | | |
| Example 10 | Recording paper | A | A | A | B |
| | (10) | | | | |
| Example 11 | Recording paper | B | B | B | B |
| | (11) | | | | |
| Example 12 | Recording paper | B | A | B | B |
| | (12) | | | | |
| Example 13 | Recording paper | B | A | B | B |
| | (13) | | | | |
| Example 14 | Recording paper | A | A | A | A |
| | (14) | | | | |
| Example 15 | Recording paper | A | A | A | A |
| | (15) | | | | |
| Example 16 | Recording paper | A | A | A | A |
| | (16) | | | | |
| Example 17 | Recording paper | B | B | B | C |
| | (17) | | | | |
| Example 18 | Recording paper | B | C | B | C |
| | (18) | | | | |
| Example 19 | Recording paper | C | C | C | C |
| | (19) | | | | |
| Example 20 | Recording paper | A | A | A | A |
| | (20) | | | | |
| Comparative | Recording paper | C | C | D | D |
| Example 1 | (R-1) | | | | |
| Comparative | Recording paper | C | D | C | D |
| Example 2 | (R-2) | | | | |
| Comparative | Recording paper | D | D | D | D |
| Example 3 | (R-3) | | | | |
| Comparative | Recording paper | C | D | D | D |
| Example 4 | (R-4) | | | | |

### <Quality Evaluation Method>

The measurement methods for the evaluations shown in the Table 1 and the Table 2 are as follows.

### (1) Basis Weight Measurement Method

It is measured by the method of the JIS P-8124.

### (2) Size Pressing Agent Adhesion Amount Measurement Method

It is calculated from the difference between the basis weight before size pressing and the basis weight after the size pressing by the method of the JIS P-8124.

### (3) Internal Bonding Force Measurement Method

The internal bonding force is measured by the method mentioned in the attached manual using an internal bond tester produced by KUMAGAYA RIKI Kogyo Corp. according to the method defined in the JAPAN TAPPI No. 18-2.

### (4) Measurement Method for CD Tensile Elastic Modulus of Paper

After adjusting the moisture of a specimen (15 mm width, 150 nun length) with the longer side direction provided in the CD by leaving in a standard state (temperature: 23° C., humidity: 50%) for one night, it is evaluated with the tensile speed in the CD of 5 mm/min and the modulus is calculated from the value thereby based on the method of the JIS P-8113.

### (5) Curl Evaluation by the Electrophotographic Recording System

The paper produced by the above-mentioned method with the moisture adjustment for 12 hours or more in a 23° C., 50% RH environment is provided for having one side copying with the felt side surface of the paper (the side opposite to the dehydrated side at the time of the paper production) provided as the printing side using Docu Print 260 produced by FUJI XEROX PRINTING SYSTEMS Corp. for the following evaluation. Printer output is carried out for the paper cut out in the A4 size with the MD (paper production direction) provided as the longitudinal direction without placing an image for evaluating the running performance according to the following evaluation criteria.

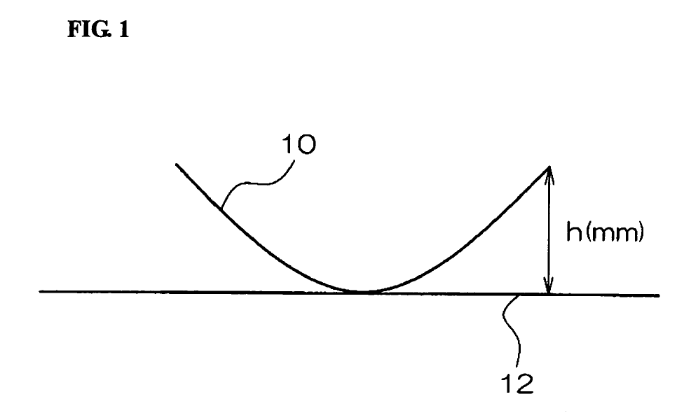

FIG. 1 is an explanatory diagram for the curl measurement after the thermal fixation. As shown in FIG. 1, the curl height h of 1 paper 10 after the thermal fixation is the maximum value of the distance between the top end part of the paper 10 and a level block 12 at the time of placing the paper 10 on the level block 12. The measured h value is evaluated according to the following criteria. A, B, and C are of the tolerable level.

### A: h<20 mm

### B: 20 mm<h<35 mm

### C: 35 mm<h<50 mm

### D: h>50 mm

### (6) Evaluation of Paper Winding in Fixing Device

The paper produced by the above-mentioned method with the moisture adjustment for 12 hours or more in a 23° C., 50% RH environment is provided for having one side copying with the felt side surface of the paper (the side opposite to the dehydrated side at the time of the paper production) provided as the printing side using DocuCentre Color 500 produced by FUJI XEROX CO., LTD. for the following evaluation. Printer output is carried out for the paper cut out in the A4 size with the MD (paper production direction) provided as the longitudinal direction with a black 100% image placed for evaluating the running performance according to the following evaluation criteria. A, B, and C are of the tolerable level.

### A: without generation of either fixing device paper winding, or paper winding mark

### B: with an extremely slight paper winding mark (an extremely slight in-plane density decline point is present)

### C: with a slight paper winding mark (a slight in-plane density decline point is present)

### D: with a fixing device paper winding or a fixing device paper winding mark (an extreme density decline point is present)

### (7) Curl Evaluation by the Ink Jet Recording System

### Curl immediately after printing evaluation

The paper produced by the above-mentioned method has the moisture adjustment for 12 hours or more in a 23° C., 50% RH environment. With a 5 mm margin provided, the recording paper of the postcard size is provided for having a 100% black solid image printed using N2100 produced by CANON Corp. for measuring the hanging curl immediately after printing generated on the side opposite to the printing side. The measurement value converted to the curvature is evaluated. The evaluation criteria are as follows, and A, B, and C are of the tolerable level.

### A: less than 20 m⁻¹

### B: 20 m⁻¹ or more and less than 35 m⁻¹

### C: 35 m⁻¹ or more and less than 50 m⁻¹

### D: 50 m⁻¹ or more

### Curl after leaving to dry evaluation

The paper produced by the above-mentioned method has the moisture adjustment for 12 hours or more in a 23° C., 50% RH environment. With a 5 mm margin provided, the recording paper of the postcard size is provided for having a 100% black solid image printed using N2100 produced by CANON Corp. and left in a 23° C., 50% RH environment placed flatly with the printing side upward for measuring the hanging curl generation amount after leaving for 100 hours after printing.. The measurement value converted to the curvature is evaluated. The evaluation criteria are as follows, and A, B, and C are of the tolerable level.

### A: less than 15 m⁻¹

### B: 15 mm⁻¹ or more and less than 30 m⁻¹

### C: 30 mm⁻¹ or more and less than 75 m⁻¹

### D: 75 m⁻¹ or more

All publications, patent applications, and technical standards mentioned in this specification are herein incorporated by reference to the same extent as if such individual publication, patent application, or technical standard was specifically and individually indicated to be incorporated by reference.

It will be obvious to those having skill in the art that many changes may be made in the above-described details of the exemplary embodiments of the present invention. The scope of the invention, therefore, should be determined by the following claims.

What is claimed is:

1. A recording paper using at least a cellulose pulp as a raw material, the recording paper comprising a thermosetting material that is a natural product, an extract of a natural product or a derivative of a natural product.

2. The recording paper of claim 1, wherein the internal bonding force is about 0.30 N.m or more.

3. The recording paper of claim 1, wherein the tensile elastic modulus in the cross direction is about 3,000 MPa or more.

4. The recording paper of claim 1, wherein the content ratio of the thermosetting material in the recording paper is about 0.1% by weight to 5.5% by weight.

5. The recording paper of claim 2, wherein the tensile elastic modulus of the recording paper in the cross direction is about 3,000 MPa or more.

6. The recording paper of claim 2, wherein the content ratio of the thermosetting material in the recording paper is about 0.1% by weight to 5.5% by weight.

7. The recording paper of claim 3, wherein the content ratio of the thermosetting material in the recording paper is about 0.1% by weight to 5.5% by weight.

8. A recording paper using at least a cellulose pulp as a raw material, the recording paper comprising a thermosetting material that is a natural product, an extract of a natural product or a derivative of a natural product, and that comprises at least one kind of group selected from β 1,3-glucan and a β 1,3-glucan derivative.

9. The recording paper of claim 8, wherein the internal bonding force of the recording paper is about 0.30 N.m or more.

10. The recording paper of claim 8, wherein the tensile elastic modulus of the recording paper in the cross direction is about 3,000 MPa or more.

11. The recording paper of claim 8, wherein the content ratio of the thermosetting material in the recording paper is about 0.1% by weight to 5.5% by weight.

12. The recording paper of claim 9, wherein the internal bonding force of the recording paper is about 0.30 N.m or more.

13. The recording paper of claim 9, wherein the tensile elastic modulus of the recording paper in the cross direction is about 3,000 MPa or more.

14. The recording paper of claim 9, wherein the content ratio of the thermosetting material in the recording paper is about 0.1% by weight to 5.5% by weight.

15. A recording paper using at least a cellulose pulp as a raw material, the recording paper comprising a thermosetting material that is a natural product, an extract of a natural product or a derivative of a natural product and that comprises at least one kind of group selected from a shellac and a shellac derivative.

16. The recording paper of claim 15, wherein the internal bonding force of the recording paper is about 0.30 N.m or more.

17. The recording paper of claim 15, wherein the tensile elastic modulus of the recording paper in the cross direction is about 3,000 MPa or more.

18. The recording paper of claim 15, wherein the content ratio of the thermosetting material in the recording paper is about 0.1% by weight to 5.5% by weight.

19. The recording paper of claim 16, wherein the tensile elastic modulus of the recording paper in the cross direction is about 3,000 MPa or more.

20. The recording paper of claim 19, wherein the content ratio of the thermosetting material in the recording paper is 0.1% by weight to 5.5% by weight.
